(19) United States
(12) Patent Application Publication
(10) Pub. No.: US 2009/0136282 A1
(43) Pub. Date: May 28, 2009

(54) Disposable Body Wax Applicator System and Method

(76) Inventor: Tarajee Brown, Capitol Heights, MD (US)

Correspondence Address: The Marbury Law Group, PLLC, 11800 SUNRISE VALLEY DRIVE, SUITE 1000, RESTON, VA, 20191, US

(21) Appl. No.: 12/275,716

(22) Filed: Nov. 21, 2008

Related U.S. Application Data
(60) Provisional application No. 61/003,907, filed on Nov. 23, 2007.

(51) Int. Cl. A46B 11/08; B43K 5/14

(52) U.S. Cl. 401/1; 401/132; 401/138; 401/137

(57) ABSTRACT

A single-use quantity of body wax is stored in elongated disposable dispensers. The dispensers are formed from hollow thermoplastic and are heated with a heater to melt the body wax. A dispenser tip is opened and the wax is squeezed out of the dispenser and spread over the desired area using a substantially flat surface of the elongated disposable dispenser. The dispenser is then disposed of after the single use. Additional dispensers can be of various sizes and are used for other body areas. A preferred heater holds multiple dispensers vertically in openings or holes and uses AC power to heat and melt the body wax for use.

### RELATED APPLICATIONS

This application claims the benefit of Provisional Application Ser. No. 61/003,907, filed Nov. 23, 2007, which is hereby incorporated by reference for all purposes.

### BACKGROUND

Various methods of hair removal are known in the prior art. For example, the hair can be shaved from the body or can be removed by the use of tweezers or other instruments which pluck the hairs from the skin, such as devices including bent rotating coil springs and the like. In addition, chemical depilatory preparations and waxes have been formulated for the purpose of hair removal. Conventional depilatory preparations, often containing sulfide chemicals, act by weakening the structure of the hair to such an extent that scraping the cream off the skin breaks the hair at skin level and thus removes it. Alternatively, waxes can be applied to the skin which can then be peeled away with the hairs embedded therein.

Currently, waxes are increasing in popularity. Epilatory waxes are typically supplied as generally solid materials that are melted in a pot prior to use. The molten material is applied to the skin, where it cools and is then peeled away together with the unwanted hair. Often, a tool such as a spatula or stirrer is provided with the wax composition for applying the composition to the skin. Often, wooden tongue depressors are used for stirring and spreading the wax. An issue that arises at waxing establishments is that it is common practice to reuse wax (and possibly even applicators) between different clients, which is clearly a very unsanitary practice.

For home users, various hot wax dispensers have been developed.

One prevalent style is the “roll-on” hot wax dispenser. These dispensers suffer from various problems. The amount of wax in the dispensers takes a long time to heat up and often requires use of a hand-held heater in order to apply hot wax. Also, the use of a roller can prevent precise application of wax to a small area, the roller tends to spread the wax too thin for coarse hair, and the roller can spread contagions from one part of the body to another due to the roller (which can pick up contagions from the skin and transfer it to the wax inside the dispenser). While typically disposable, these “roll-on” hot wax dispensers are not single-use devices.

Accordingly, a need remains for a solution to the unsatisfactory and unsanitary practices of the prior art.

### BRIEF SUMMARY

A disposable body wax applicator system and method as disclosed herein uses disposable, single-use wax-containing applicators to overcome the above-noted shortcomings. The disclosed embodiments satisfy such a need by providing a kit that is convenient and easy to use, is durable yet lightweight in design, is versatile in its applications, and provides users with a sanitary means of removing unwanted hair from their bodies. As a single-use wax applicator kit, the disclosed embodiments effectively prevent the spread of germs and bacteria so often associated with repeatedly heating and cooling hot wax. Further, because each applicator is utilized only once and does not contact a common wax supply or different parts of the body, the transfer of dead skin cells, hair and other unsanitary detritus from the user to the supply of wax or to different parts of the body is effectively eliminated. As such, by eliminating the spread of these harmful agents between locations and users, use of the disclosed embodiments ensures the health and well being of the user.

Body wax is sealed inside hollow plastic applicators, which come in various sizes for different applications. The applicators are warmed so as to melt the wax and then opened individually to dispense and apply the wax to the area of the body having the unwanted hair. The hollow plastic applicators are preferably shaped to allow precise application to the area being waxed and can include a handle portion that does not contain hot wax. When inserted vertically into an associated heater, the handle portion extends from the top of the heater.

In use, the applicator can spread the dispensed molten body wax to a thickness required by the hair being removed. The applicator can then be disposed of to maintain sanitary conditions, with a new applicator and new body wax used for the next application.

### BRIEF DESCRIPTION OF THE DRAWINGS

FIG. 1A illustrates a disposable body wax applicator in accordance with a first embodiment;

FIG. 1B illustrates a tapered dispensing tip of a disposable body wax applicator in accordance with a first embodiment;

FIG. 2 illustrates a disposable body wax applicator in accordance with a second embodiment;

FIG. 3 illustrates a disposable body wax applicator kit in accordance with an embodiment.

### DETAILED DESCRIPTION

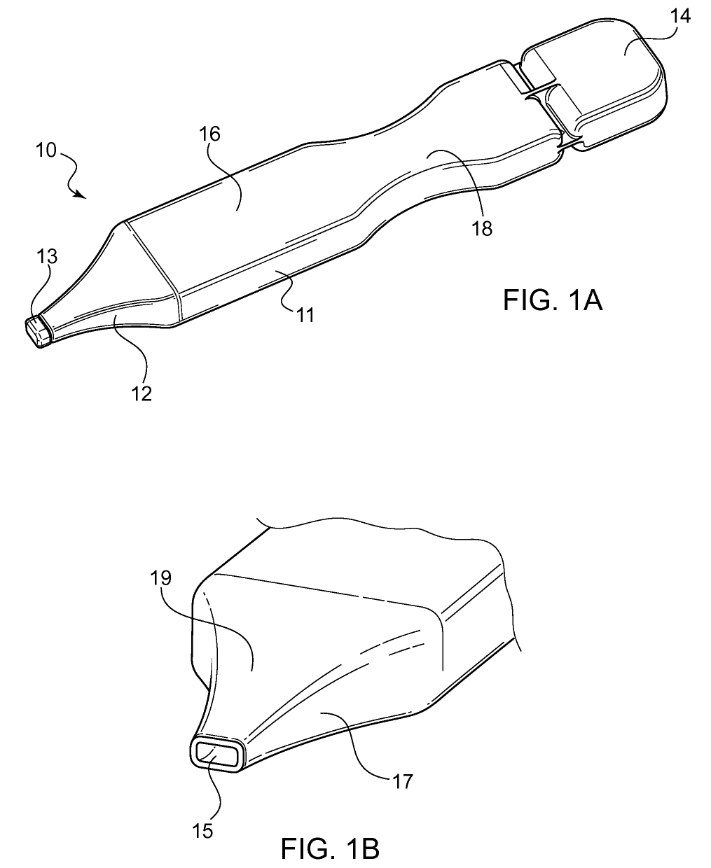

Referring to FIG. 1A, a first embodiment of a disposable body wax applicator 10 is illustrated. Applicator 10 is configured to hold and dispense approximately two (2) tablespoons (˜30 ml) of body wax for use in an area such as a bikini line or an underarm. The body wax can be any suitable formulation, including but not limited to hypoallergenic tallow formulas and sugar wax formulas. The applicator 10 is elongated and shaped so that it can be used to spread the wax after it is dispensed. As illustrated, applicator 10 is approximately 7 inches (˜18 cm) long, approximately 1¼ inches (˜3.18 cm) wide and approximately ½ inch (˜1.2 cm) deep. The applicator 10 is generally hollow and formed from a thermoplastic resin such as polypropylene that can withstand the temperatures near 130° F. needed to melt the body wax. The walls of the applicator 10 provide sufficient stiffness to allow the applicator 10 to be used to spread the molten (i.e., hot) body wax in the manner of prior art spatulas and wooden applicators, but have sufficient flexibility to allow the hot body wax to be manually dispensed by squeezing of the applicator 10.

A hollow body 11 of applicator 10 is used to store a predetermined amount of body wax (e.g., 2 tablespoons). The hollow body 11 extends for a major portion of the applicator 10 and further includes a flat surface area 16 that is used to spread the hot body wax during use. The applicator 10 includes a dispensing tip 12 at one end that is preferably tapered to allow precise application of molten body wax. The tapered dispensing tip 12 preferably has one or more curved surfaces and terminates at a removable end cap 13 that covers or seals a wax-dispensing opening (not shown). The end cap 13 can take various forms, such as an insertable plug, a removable cover, a “breakaway” frangible cover, or a “breakaway” frangible tip. Because the applicator is meant as a single use device, a breakaway-type closure is preferred so as to prevent an attempt by a user to reseal and reuse the applicator 10.

The opposite end of the applicator 10 can include a handle portion 14. If the handle portion 14 is hollow and empty, it will not retain as much heat and will be more comfortable for a user to grip when removing the applicator 10 from a heater means.

The hollow body 11 can be a prismatic body with a substantially rectangular cross-section as illustrated or any other suitable cross-section with at least one flat side, such as a triangle. The illustrated hollow body 11 has an opposing flat surface area opposite flat surface area 16 that can also be used for spreading molten wax. The rectangular cross-section can be uniform, so as to form a straight wax-spreading edge, or it can have a varying major dimension so as to form a portion of flat surface area 18 that has a curved wax-spreading edge. The curved edge of surface area 18 can be used to match the curvature of the bikini line in the crotch area.

As illustrated in FIG. 1B, removal of the end cap exposes a wax-dispensing opening 15 of the tapered dispensing tip. The opening 15 can be any size and shape suitable for the dispensing of molten body wax, but is preferably in a shape that will allow precise dispensing of molten body wax at the desired location, such as the illustrated slit. Curves in tapered walls 17 and 19 allow the opening 15 to be positioned in a desired location. Depending upon the manufacturing technique, the opening 15 may also be used for filling the predetermined amount of body wax into the hollow body of the dispenser.

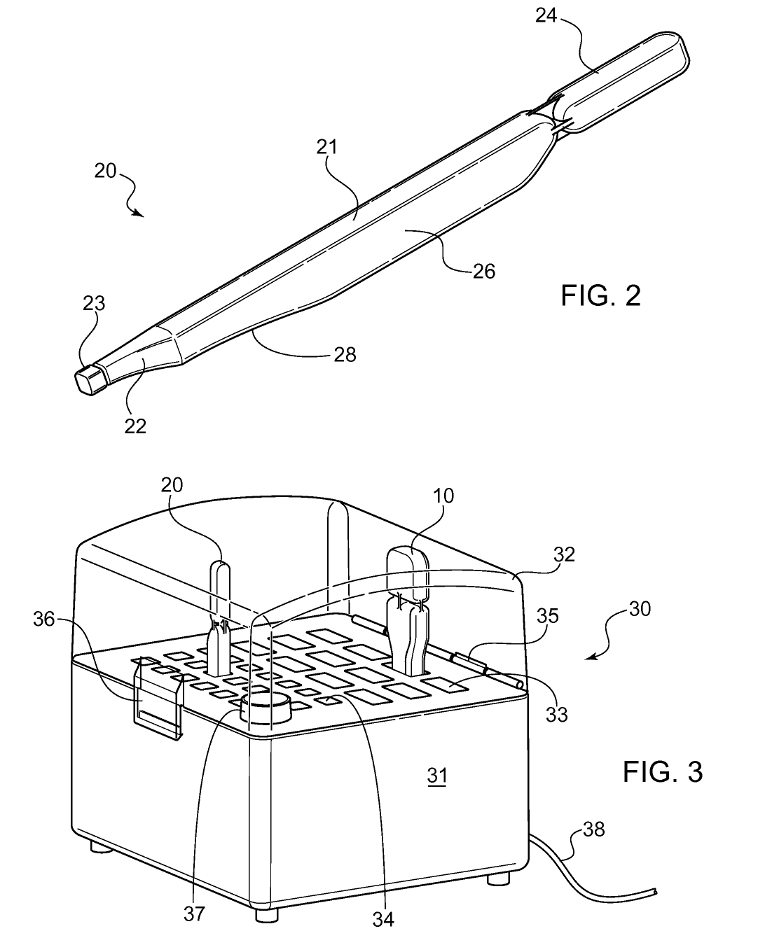

FIG. 2 illustrates a second embodiment comprising a smaller sized applicator 20. Applicator 20 is configured to hold and dispense approximately one (1) teaspoon (˜5 ml) of body wax for use in an area such as an eyebrow or an upper lip. The applicator 20 is elongated and shaped so that it can be used to spread the wax after it is dispensed. As illustrated, applicator 20 is approximately 7 inches (˜17.7 cm) long, approximately 0.56 inches (˜1.42 cm) wide and approximately 0.4 inches (˜1 cm) deep. The applicator 20 is, again, generally hollow and formed from a thermoplastic resin such as polypropylene that can withstand the temperatures near 130° F. needed to melt the body wax. The walls of the applicator 20 provide sufficient stiffness to allow the applicator 20 to be used to spread the molten (i.e., hot) body wax in the manner of prior art spatulas and wooden applicators, but have sufficient flexibility to allow the hot body wax to be manually dispensed by squeezing of the applicator 20.

A hollow body 21 of applicator 20 is used to store a predetermined amount of body wax (e.g., 1 teaspoon). The hollow body 21 extends for a major portion of the applicator 20 and further includes a flat surface area 26 that is used to spread the hot body wax during use. The applicator 20 includes a dispensing tip 22 at one end that is preferably tapered to allow precise application of molten body wax. The tapered dispensing tip 22 preferably has one or more curved surfaces and terminates at a removable end cap 23 that covers or seals a wax-dispensing opening (not shown). The end cap 23 can take various forms, such as an insertable plug, a removable cover, a “breakaway” frangible cover, or a “breakaway” frangible tip. Because the applicator is meant as a single use device, a breakaway-type closure is preferred so as to prevent an attempt by a user to reseal and reuse the applicator 20.

The opposite end of the applicator 20 can include a handle portion 24. If the handle portion 24 is hollow and empty, it will not retain as much heat and will be more comfortable for a user to grip when removing the applicator 20 from a heater means.

The hollow body 21 can be a prismatic body with a substantially rectangular cross-section as illustrated or any other suitable cross-section with at least one flat side, such as a triangle. The illustrated hollow body 21 has an opposing flat surface area opposite flat surface area 26 that can also be used for spreading molten wax. The rectangular cross-section can be uniform, so as to form a straight wax-spreading edge, or it can have a varying major dimension so as to form a portion of flat surface area 28 that has a curved wax-spreading edge. The curved edge of surface area 28 can be used to match the curvature of the eyebrow or upper lip.

While the heating means can take any suitable form, such as a hot liquid bath, an oven or a microwave oven, a preferred heating means 30 is illustrated in FIG. 3. Heater 30 includes a base 31 that includes an interior heating element (not shown) that is powered with AC electricity provided by cord 38. The base 31 includes a plurality of openings or holes 33, 34 that are sized to receive disposable applicators 10, 20. The holes 33, 34 preferably have a cross-section slightly larger than the cross-section of applicators 10, 20 to allow easy insertion and close coupling with the internal heating element. The depth of the holes 33, 34 should be less than the length of the elongated applicators 10, 20 so that they can be readily removed by grasping the handle portions 14, 24.

A temperature control switch 37 is used to control the heating element in order to provide a temperature of approximately 130° F. to the disposable dispensers 10, 20 in order to melt the body wax stored therein so as to form molten body wax that can be dispensed and used. The switch preferably includes an automatic cutoff means or circuit that acts in response to temperature, time, or both so as to prevent dangerous overheating conditions.

In a preferred embodiment, the exterior of the base 31 is formed from heat resistant ABS plastic resin and the heater 30 includes a clear acrylic lid 32 attached to the base 31 with hinges 35 and latch 36. In this way, the lid 32 can be used to retain heat for melting of the wax in inserted applicators 10, 20 in order to prepare them for use. The clear lid 32 allows a user to visually ascertain the number of remaining dispensers 10, 20.

Numerous other shapes and configurations can be used for the disposable applicators and the associated heater without departing from the scope of the invention as defined in the appended claims. Indeed, larger sizes of applicators for waxing legs, arms, etc. can also be manufactured. However, practical limits to the size of a disposable applicator will be reached due to various factors such as wax-removal strip size, time needed to melt larger amounts of wax, waste associated with larger amounts of wax, etc.

In a basic embodiment, a disposable body wax applicator system comprises an elongated applicator, and a heating means, wherein the applicator comprises: a hollow body containing body wax, the hollow body formed from a plastic material, a flat surface area on the hollow body suitable for spreading molten body wax, a tapered dispensing tip at a first end of the applicator comprising a wax-dispensing opening, and a removable end cap sealing the wax-dispensing opening.

Variations on this embodiment include systems further comprising a hollow handle section at a second end of the applicator and/or a second flat surface area on the hollow body spaced on an opposing side of the dispenser, wherein the opposing flat surface areas have sufficient flexibility to dispense molten wax from the wax-dispensing opening when squeezed together (and which can be made of thermoplastic polypropylene resin).

Other variations of this embodiment include those: wherein the removable end cap is selected from the group comprising an insertable plug, removable cover and a frangible tip; wherein the body wax is selected from the group consisting of hypoallergenic tallow formulas and sugar wax formulas; and wherein the hollow body is substantially prismatic with a rectangular cross-section, with the opposing flat surface areas comprising long sides of the rectangular cross-section.

In more specific embodiments, the long sides of the rectangular cross-section are uniform for a portion of the hollow body to form a flat-edge wax-spreading surface and the long sides of the rectangular cross-section are varied for another portion of the hollow body to form a curved-edge wax-spreading surface.

In other embodiments, the elongated applicators are of varying sizes containing varying amounts of body wax. More particularly, embodiments can include an elongated applicator of a first size containing approximately 30 ml (˜2 tablespoons) of body wax and a curved-edge wax-spreading surface suitable for wax application to a bikini area or underarm, and an elongated applicator of a second size containing approximately 5 ml (˜1 teaspoon) of body wax and a curved-edge wax-spreading surface suitable for wax application to an eyebrow or upper lip.

Although the means for heating can take any suitable form, in one preferred embodiment, the means for heating comprises a base with a heating element and a plurality of holes sized to accept a plurality of elongated applicators, as well as a temperature control switch for the heating element. Optional forms of this embodiment can include a removable cover for the means for heating and an AC power source for the heating element.

The means for heating for another preferred embodiment comprises a base with an AC heating element and a plurality of vertical holes sized to accept a plurality of elongated applicators with the handles extending outside the holes. This embodiment further includes a temperature control switch for the heating element and a hinged lid. The temperature control switch can optionally comprise a timing circuit to automatically turn the heater off after a pre-determined period of time. The exterior of the base is preferably formed from acrylonitrile butadiene styrene (ABS) resin and the hinged lid is formed from transparent PMMA acrylic.

A method embodiment for dispensing body wax for hair removal comprises heating a single-use quantity of body wax stored in a disposable elongated dispenser, breaking away a frangible cover to open a wax-dispensing opening on the disposable elongated dispenser, squeezing the disposable elongated dispenser to dispense molten body wax through the wax-dispensing opening at a desired location on a body, and spreading the molten body wax over the desired area using a substantially flat surface of the disposable elongated dispenser. The disposable elongated dispenser can then be disposed and an additional disposable elongated dispenser can be used for applying molten body wax to additional areas.

Disclosed embodiments have utility in both a home environment and a salon environment to prevent the spread of contagions via the body wax or the applicators.

A disposable body wax applicator system and method have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the,” is not to be construed as limiting the element to the singular.

What is claimed is:

1. A disposable body wax applicator system, comprising:
an elongated applicator, the applicator comprising:
a hollow body containing body wax, the hollow body formed from a plastic material;
a flat surface area on the hollow body suitable for spreading molten body wax;
a tapered dispensing tip at a first end of the applicator comprising a wax-dispensing opening; and
a removable end cap sealing the wax-dispensing opening; and
a means for heating the elongated applicator to melt the body wax in the applicator.

2. The system of claim 1, further comprising a hollow handle section at a second end of the applicator.

3. The system of claim 1, wherein the removable end cap is selected from the group comprising an insertable plug, removable cover and a frangible tip.

4. The system of claim 1, further comprising a second flat surface area on the hollow body spaced on an opposing side of the dispenser, wherein the opposing flat surface areas have sufficient flexibility to dispense molten wax from the wax-dispensing opening when squeezed together.

5. The system of claim 4, wherein the dispenser is formed from a thermoplastic resin.

6. The system of claim 5, wherein thermoplastic resin is polypropylene.

7. The system of claim 1, wherein the body wax is selected from the group consisting of hypoallergenic tallow formulas and sugar wax formulas.

8. The system of claim 4, wherein the hollow body is substantially prismatic with a rectangular cross-section, with the opposing flat surface areas comprising long sides of the rectangular cross-section.

9. The system of claim 8, wherein the long sides of the rectangular cross-section are uniform for a portion of the hollow body to form a flat-edge wax-spreading surface and the long sides of the rectangular cross-section are varied for another portion of the hollow body to form a curved-edge wax-spreading surface.

10. The system of claim 1, comprising elongated applicators of varying sizes containing varying amounts of body wax.

11. The system of claim 9, comprising an elongated applicator of a first size containing approximately 30 ml of body wax and a curved-edge wax-spreading surface suitable for wax application to a bikini area or underarm, and an elongated applicator of a second size containing approximately 5 ml of body wax and a curved-edge wax-spreading surface suitable for wax application to an eyebrow or upper lip.

12. The system of claim 1, wherein the means for heating comprises:
a base comprising a heating element and a plurality of holes sized to accept a plurality of elongated applicators; and
a temperature control switch for the heating element.

13. The system of claim 12, further comprising a removable cover for the means for heating.

14. The system of claim 12, further comprising an AC power source for the heating element.

15. The system of claim 2, wherein the means for heating comprises:
a base comprising an AC heating element and a plurality of vertical holes sized to accept a plurality of elongated applicators with the handles extending outside the holes;
a temperature control switch for the heating element; and
a hinged lid.

16. The system of claim 15, wherein the temperature control switch further comprises a timing circuit to automatically turn the heater off after a pre-determined period of time.

17. The system of claim 15, wherein an exterior of the base is formed from acrylonitrile butadiene styrene (ABS) resin and the hinged lid is formed from transparent PMMA acrylic.

18. A method of dispensing body wax for hair removal, comprising:
heating a single-use quantity of body wax stored in a disposable elongated dispenser;
breaking away a frangible cover to open a wax-dispensing opening on the disposable elongated dispenser;
squeezing the disposable elongated dispenser to dispense molten body wax through the wax-dispensing opening at a desired location on a body; and
spreading the molten body wax over the desired area using a substantially flat surface of the disposable elongated dispenser.

19. The method of claim 18, further comprising disposing of the disposable elongated dispenser.

20. The method of claim 19, further comprising using an additional disposable elongated dispenser for dispensing body wax to another desired location on a body and spreading the body wax over another desired area according to the steps of claim 18.
